(19) United States
(12) Patent Application Publication
(10) Pub. No.: US 2004/0091234 A1
(43) Pub. Date: May 13, 2004

(54) System and method of facilitating appliance behavior modification

(76) Inventors: Alexandre P.V. Delorme, Boulder, CO (US); Darwin M. Hanks, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/289,905

(22) Filed: Nov. 7, 2002

(51) Int. Cl. H04N 5/76; G11B 27/00

(52) U.S. Cl. 386/46; 386/52

(57) ABSTRACT

An electronic device comprises at least one behavior template having a description associated with recording and organization of multimedia content, and an input operable to receive multimedia content.

### TECHNICAL FIELD OF THE INVENTION

The present invention relates generally to the field of electronic devices and appliances, and more in particular to a system and method of facilitating appliance behavior modification.

### BACKGROUND OF THE INVENTION

Consumers of electronic products cite ease of use as one of the primary factors they consider when purchasing a product. The recent success of TIVO (TIVO is a trademark of TiVo Inc. of Alviso, Calif.) is a particularly illustrative example. Unlike conventional video recorders, which require a user to enter the day, time and duration of a program to record it, a user can program TIVO to record an entire season's showing of a particular show, for example, even if the show time of the program is subsequently changed. Other user programming and interactive capabilities make TIVO a vastly improved product over conventional video recorders. Consumers typically respond enthusiastically to functions that are either automated or tailored to their individual needs and desires. The more easily and quickly they can perform the desired function, and the more intuitive the user interface is configured, the more likely the consumer is to choose one product over another.

The remote control device has become the ubiquitous user interface for many consumer products. It is not uncommon to see a home outfitted with an assortment of remote controls for a variety of devices, such as television, video recorder/player, compact disc (CD) player, digital video disc (DVD) player/recorder, etc. Remote control is not limited to multimedia consumer products; ceiling fans, electric fans, window blinds, video cameras, and other electronic and electric devices are now equipped with remote control capabilities. Most of these remote controls resemble one another with similar-looking buttons and similar layout. Although consumers may replace some of the remote controls with a universal remote control device, the one-to-many control aspect of these remote control devices adds a layer of complexity to their operation. The small liquid crystal display (LCD) screens in some remote control devices are also incapable of providing more than the rudimentary feedback or status information to the users.

### SUMMARY OF THE INVENTION

In accordance with an embodiment of the present invention, an electronic device comprises at least one behavior template having a description associated with recording and organization of multimedia content, and an input operable to receive multimedia content.

In accordance with another embodiment of the invention, an electronic control device comprises a display screen, and at least one behavior template having a description of control elements to be shown on the display screen and functionality associated with the displayed control elements.

In accordance with yet another embodiment of the present invention, an electronic device comprises an output to a display screen, and at least one behavior template having a description of graphical elements to be shown on the display screen, the graphical elements being associated with the organization and playback of multimedia content.

In accordance with another embodiment of the present invention, a method of modifying the behavior of an electronic device comprises selecting a behavior template, and modifying content and functionality of a user interface of the electronic device according to the selected behavior template.

In accordance with a further embodiment of the present invention, a method comprises selecting a behavior template stored in an electronic device, and using the electronic device according to the selected behavior template.

In accordance with a further embodiment of the present invention, a method comprises selecting a behavior template, and modifying content and functionality of a user interface associated with organization and playback of multimedia content according to the selected behavior template.

In accordance with a further embodiment of the present invention, a template for modifying the behavior of an electronic device comprises a description of at least one graphical element, a description of placement of the at least one graphical element, an optional description of a background for displaying the at least one graphical element, an optional description of at least one color of the at least one graphical element, and a description of functionality of the electronic device represented by the at least one graphical element.

In accordance with yet another embodiment of the present invention, an article of manufacture comprises a computer-readable medium, which has encoded therein a description of at least one graphical element, a description of placement of the at least one graphical element, and a description of functionality of the electronic device represented by the at least one graphical element.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified diagram of an embodiment of a system and method of facilitating appliance behavior modification according to the teachings of the present invention;

FIG. 2 is an illustrative example of an embodiment of a multimedia content authoring menu screen according to the teachings of the present invention;

FIG. 3 is a top plan view of an embodiment of a modified remote control device and display screen according to the teachings of the present invention;

FIG. 4 is a simplified flowchart of an embodiment of a template editor process according to the teachings of the present invention;

FIG. 5 is a simplified flowchart of an embodiment of a template execution process according to the teachings of the present invention.

### DETAILED DESCRIPTION OF THE DRAWINGS

The preferred embodiment of the present invention and its advantages are best understood by referring to FIGS. 1 through 5 of the drawings, like numerals being used for like and corresponding parts of the various drawings.

FIG. 1 is a simplified diagram of an embodiment of a system and method of facilitating appliance behavior modification 10 according to the teachings of the present invention. A specific application of the invention facilitates the recording and authoring of multimedia content. The present invention uses behavior templates 12-18 to program and modify the behavior of certain appliances, such as cameras 20, video cameras 22, digital video recorders and players 24, televisions 26 and remote control devices 28. Remote control devices 28 are equipped with wireless communications capability, such as infrared and WiFi, for communicating with respective electronic devices that they control. Using these templates 12-18, the display and user interface functionality of these appliances can be easily programmed and tailored to suit particular applications and/or users, so that the appliances become easier to use to create professional-looking multimedia content. The term “multimedia content” herein refers to content containing any one or combination of video, audio, photograph, graphics, animation and other audio-visual content. Behavior templates may be implemented using high-level description languages, such as XML (extensible Markup Language), low-level binary languages, or other suitable languages. The templates may also include script of executable code such as Java script. In the embodiment of the present invention, behavior templates may describe the colors, formats, shapes, sounds, content and placement of graphics element displayed on a television or computer monitor screen 27, the content and placement of elements on a display 34 of a remote control device 28, and the colors, sounds, sequence and graphical elements of a multimedia presentation, for example. More details of the behavior templates are set forth below. For example, a behavior template may be used to author a DVD (digital video disc) so that a user may select a template for the text, graphics and music of a menu screen for the multimedia content on the DVD or another multimedia storage device.

A personal computer 30 or another computing device may be used to execute a behavior template editor software application 32. Referring also to FIG. 4, behavior template editor 32 may be used to access a variety of stored existing templates in a library 36 to allow a user to download an existing template, modify the existing templates, as well as allow a user to implement a behavior template from scratch. Behavior templates may be downloaded via a computer network 38 from a server (now shown), which enables the makers of the appliances to update the behavior templates and provide new behavior templates to the users. Depending on the manner in which the templates are implemented, the editor would allow the user to generate high-level descriptive language, script language, low-level binary language, or some other suitable language to implement a behavior template. Behavior template editor 32 preferably comprises a graphical user interface that enables the user to drag and drop existing template code segment blocks and link them to form the templates. In the flowchart shown in FIG. 4, the user may select a behavior template type, as shown in block 40. One type of behavior template is automatic multimedia presentation authoring, to be downloaded to digital video recorder/player 24, which provides a multimedia content presentation menu screen (an example 42 shown in FIG. 2) with graphics elements 43-46 tailored to specific events (wedding, baby shower, zoo outing, birthday, graduation, soccer game, etc.), and buttons for certain scene/chapters suitable for the specific event (such as “Getting Ready,” “Friends,” “Family,” “Ceremony,” “Celebrate!”, etc.). Another multimedia presentation authoring behavior template may sequence a plurality of still images into a slideshow presentation, for example, and provide suitable accompanying music.

In addition, the same behavior template, or a component thereof, may be downloaded to video camera 22 or another content source. Such a behavior template is a content capturing behavior template, which instructs the user to obtain or capture footages or scenes of certain content that would fit neatly into the scene/chapters defined in the behavior template. Such utility enables the user to quickly videotape an event and author the multimedia presentation without spending a tremendous amount of time in post-production, such as viewing all the footages, editing the scenes and putting the edited scenes together in some sequence. An interesting content capturing behavior template may be implemented with collaborative effort of well-known cinematic directors, for example, Steven Spielberg, George Lucas or Ridley Scott, which would provide directorial input to the user during videotaping. For example, the behavior template may display, on the LCD of the video camera, “Capture bride in preparation,” “Capture groom in preparation,” “Capture site and surrounding areas,” “Capture wedding parties,” “Capture ceremony,” etc. in a creative sequence and timing for filming a wedding, and may provide camera angle, movement, focus, lighting and other creative suggestions. Ideally, in addition to visual cues on the LCD, behavior template may send the user audio cues via the appliance speakers or headphones (not explicitly shown) for these scene changes and other inputs.

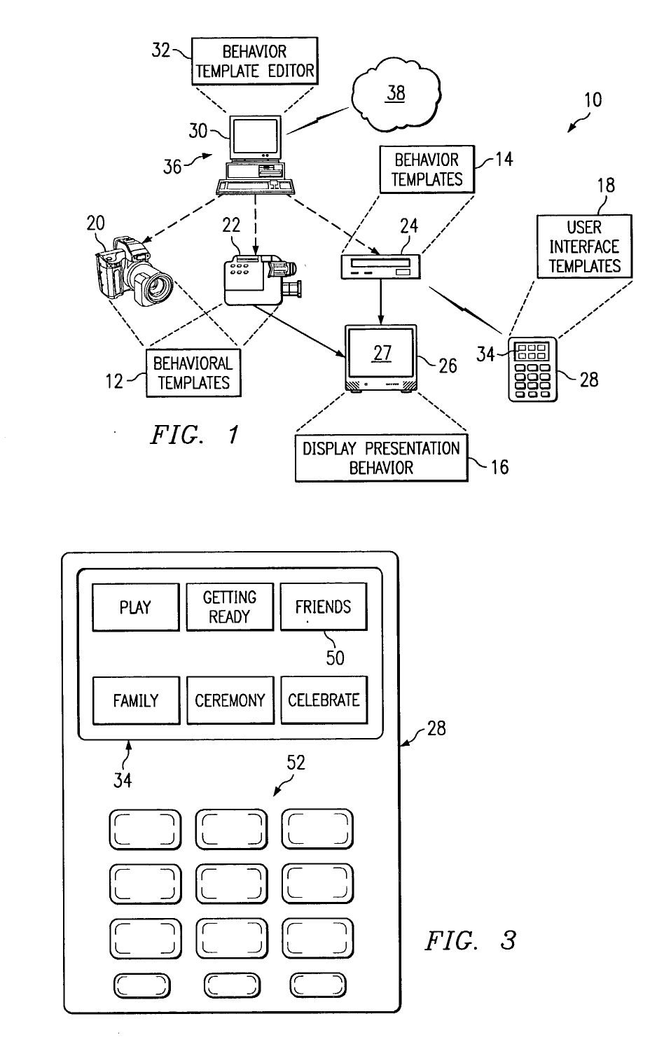

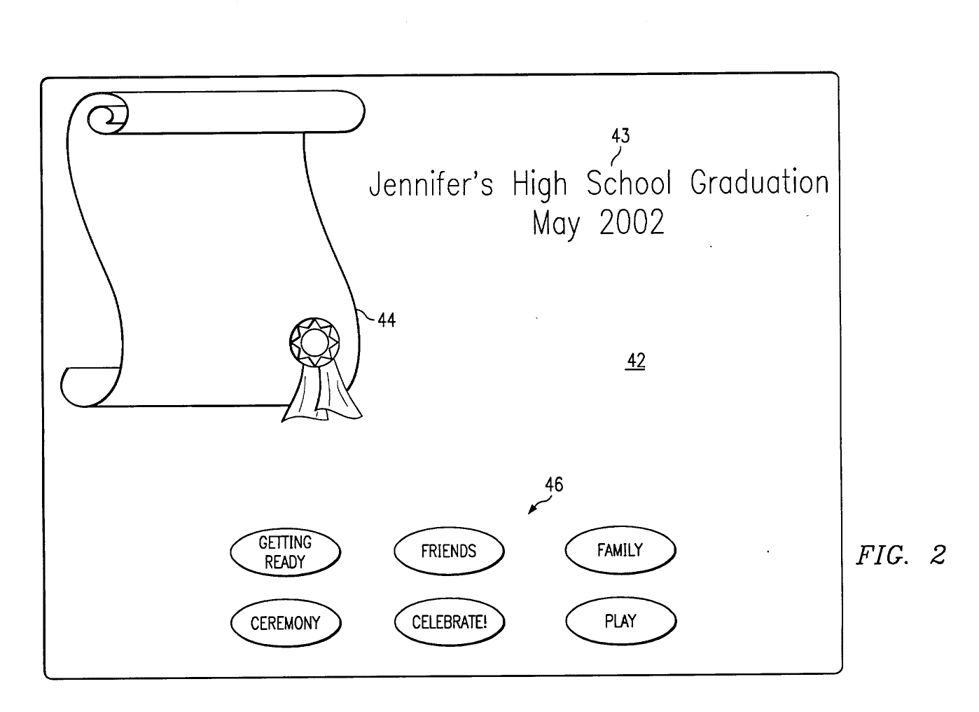

Another type of behavior templates, user interface templates, can also be selected in block 40 in FIG. 4. Such templates are used to transform the display and functionality of a control device, such as a remote control device 28. For example, as seen in FIG. 3, a display 34 of remote control device 28 is instructed by a behavior template to display a number of buttons 50 that correspond with buttons 46 on the presentation menu screen shown in FIG. 2. These buttons may map to physical buttons 52 on the device or may represent additional buttons on a touch-sensitive screen, for example.

Returning to FIG. 4, if the user does not select an existing template as determined in block 56, then the user desires to create a new template, as shown in block 58. Otherwise, template editor 32 presents the selected template to the user and allows the user to modify the template and save the modified template, as shown in blocks 60 and 62. Template editor 32 may be a text editor or an editor with a graphical interface. Frequently used template functions or sequences may be selectively retrieved by the user to be used in implementing the template. For example, the editor may allow the user to easily specify and change the color, format, shape and the placement of background, text, graphical elements and other menu content. An example of a behavior template written in pseudo-code is set forth below:

<Head>
<Template name> wedding-1 </template name>
<Template author> Alex </template author>
<Template version> 1.0.1 </template version>
<Creation date> 06-12-01 </creation date>
<Copy right> read-only </copyright>
. . .
</head>
<body>
<Movie>
<Movie title> Wedding </Movie Title>
<Movie date>
<Meta data> Wedding, John, Carla, 2002, Denver </Meta Data>
<Chapter 1> Wife's family </chapter 1>
<Chapter sync info> 8375429 </Chapter sync info>

<Scene 1>
<Title> Wife's parents </Title>
<Proposed Duration> 70 </Proposed Duration>
<Actual duration> 63 </Actual duration>
<Narration> narration.wav </Narration>
<Narration Audio Level> 3 </Narration Audio level>
<Music background> music.mp3 </Music background>
<Music background audio level> 2 </Music background audio level>
<Scene directorial input> this scene should include a shot of the
bride's parents in an outdoor situation.
The light should come from the back of the video
camera. Shooting tips: 1- Zoom on the wife's mother
first and pan for the father. 2- Turn the microphone off and add the
narrative later. 3- Shoot the parents while they are walking around.
<Web link> http:www.provideo.com/wedding/chap1/scene1 </Web
link>
. . .

</Scene1>
<Transition Scene 1 - Scene 2>

<Transition effect> dissolve </Transition effect>
<Transition duration> 10 </Transition duration>
<Transition special effect> none </Transition special effect>
<Web link> http:www.provideo.com/wedding/trans/chap 1-2 </Web
link>
. . .

</Transition Scene 1 - Scene 2>
<Scene 2>
. . .
</Chapter 1>

<Transition Chapter 1 - Chapter 2>
. . .
</Transition Chapter 1 - Chapter 2>

<Chapter 2>
. . .
</Chapter 2>
. . .
</Movie>
<Trailer>
. . .
</Trailer>
. . .
</Body>

The above pseudo-code is an exemplary template that the user could load into a video digital camera. This template directs the user in the shooting of a wedding. The <head> section describes the template document, the author, the creation date, the version, and other information about the template. The <body> section describes the behavior define by the template. Many behavior descriptions will be used by the user to shoot the scene required by the scenario. Other behavior descriptions target the video camera to tune the input audio level of the microphone or control the zoom to shoot a particular scene. In this case, it describes a wedding scenario and the different shots which are to be taken.

The saved template is then downloaded to the selected device, as shown in block 64. It may be seen that behavior templates may be downloaded to a number of devices for execution, depending on the functionality of the behavior template. For example, multimedia content presentation behavior templates are typically downloaded to video recorder/player (DVD writer/player) 24, multimedia content capturing behavior templates are typically downloaded to multimedia capturing devices or sources 20 and 22, user interface templates are typically downloaded to remote control devices and other user input devices. The process ends in block 66.

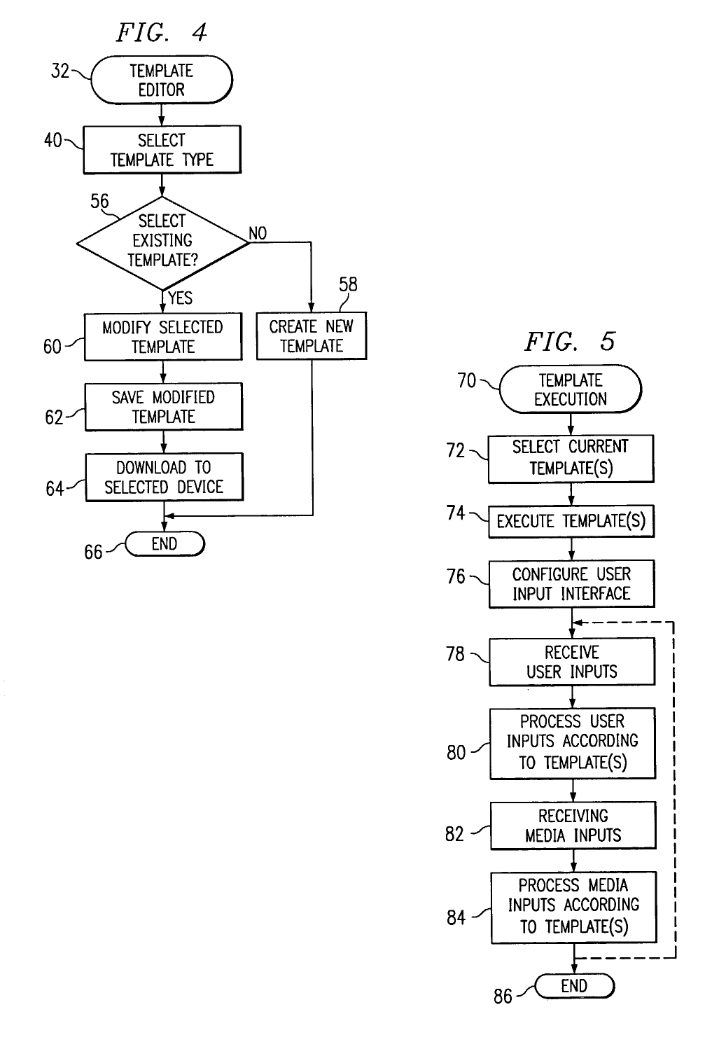

FIG. 5 is a simplified flowchart of an embodiment of a template execution process 70 according to the teachings of the present invention. A device, such as a video camera 22 may have more than one behavior template stored therein. The devices may be purchased by consumers with a suite of behavior templates already built-in and accessible. A user may select a template for execution, as shown in block 72. The device then executes the selected behavior template, as shown in block 74. A function of the behavior template may be to configure the user input interface of the device, which may include its remote control device, as shown in block 76. Using this configured user interface, the user provides input, as shown in block 78. The user's input is processed and treated according to the executing behavior template, as shown in block 80. The device may also receive multimedia input, such as capturing video and audio content, for example, as shown in block 82. The device processes and treats the captured multimedia content according to the behavior template, as shown in block 84. The template may insert meta data into appropriate locations in the video stream. As described above, this may include marking segments of the multimedia content as belonging to certain scenes or chapters, for example. The process from blocks 76 to 84 is repeated until completed, as shown in block 86. FIG. 5 is intended to be a simplified flowchart that should be loosely interpreted. For example, it should be noted that the exemplary process shown herein may contain optional steps that are not required depending on the implementation of the functionality of the behavior template. Furthermore, step 84 may be performed until all media input has been completed or as user input and media input are being received.

The present invention provides an added layer of sophistication and functionality to existing consumer appliances and devices to facilitate the ease-of-use thereof. For some user interfaces where the amount of display is limited, such as a remote control device, the ability to custom tailor the user interface using behavior templates enables users to provide more intuitive input. Multimedia presentation authoring such as DVD authoring becomes, with the use of behavior templates, a more streamlined operation that saves the users time yet produces a professional output. Multimedia content capturing behavior templates further provide instructions and direction on content and other aspects during videotaping so that the captured video can be quickly edited and sequenced into a multimedia presentation.

What is claimed is:

1. An electronic device, comprising:
at least one first behavior template having a description associated with recording and organization of multimedia content; and
an input operable to receive multimedia content.

2. The electronic device, as set forth in claim 1, wherein the at least one first behavior template having descriptions containing directorial instructions associated with recording and organization of multimedia content.

3. The electronic device, as set forth in claim 1, wherein the at least one first behavior template having descriptions of scenes suitable for a particular event and functionality associated with recording and organization of multimedia content for the described scenes.

4. The electronic device, as set forth in claim 1, further comprising:
a display screen; and
at least one, second behavior template having a description of control elements to be shown on the display screen and functionality associated with the displayed control elements related to recording and organization of the multimedia content.

5. The electronic device, as set forth in claim 4, wherein the control elements are buttons shown on the display screen.

6. The electronic device, as set forth in claim 1, wherein the multimedia content is selected from a group consisting of video, audio, photograph, graphics, and animation.

7. An electronic control device, comprising:
a display screen; and
at least one behavior template having a description of control elements to be shown on the display screen and functionality associated with the displayed control elements.

8. The electronic control device, as set forth in claim 7, wherein the control elements are buttons shown on the display screen.

9. The electronic control device, as set forth in claim 7, further comprising a wireless connection with an electronic device having a second display screen, the control elements operable to control the content and format of images to be displayed on the second display screen.

10. An electronic device, comprising:
an output to a display screen; and
at least one behavior template having a description of graphical elements to be shown on the display screen, the graphical elements being associated with the organization and playback of multimedia content.

11. The electronic device, as set forth in claim 10, wherein the at least one behavior template having descriptions of scenes suitable for a particular event and functionality associated with recording and organization of multimedia content for the described scenes.

12. The electronic device, as set forth in claim 10, wherein the graphical elements are buttons shown on the display screen.

13. The electronic device, as set forth in claim 10, wherein the multimedia content is selected from a group consisting of video, audio, photograph, graphics, and animation.

14. A method of modifying the behavior of an electronic device, comprising:
selecting a behavior template; and
modifying content and functionality of a user interface of the electronic device according to the selected behavior template.

15. The method, as set forth in claim 14, further comprising controlling the electronic device using the modified behavior of the user interface.

16. The method, as set forth in claim 14, further comprising editing a selected behavior template using a behavior template editor.

17. The method, as set forth in claim 14, further comprising generating a new behavior template using a behavior template editor.

18. The method, as set forth in claim 14, wherein selecting a behavior template comprises selecting a behavior template having descriptions of a plurality of control elements for controlling the electronic device.

19. A method, comprising:
selecting a behavior template stored in an electronic device; and
using the electronic device according to the selected behavior template.

20. The method, as set forth in claim 19, wherein using the electronic device comprises capturing and storing multimedia content according to directorial instructions described in the selected behavior template.

21. A method, comprising:
selecting a behavior template; and
modifying content and functionality of a user interface associated with organization and playback of multimedia content according to the selected behavior template.

22. The method, as set forth in claim 21, wherein selecting a behavior template comprises selecting a behavior template having descriptions of a menu with menu elements for multimedia playback.

23. The method, as set forth in claim 21, wherein selecting a behavior template comprises selecting a behavior template having descriptions of a menu with buttons representing scenes of a multimedia content recording.

24. A template for modifying the behavior of an electronic device, comprising:
a description of at least one graphical element;
a description of placement of the at least one graphical element;
an optional description of a background for displaying the at least one graphical element;
an optional description of at least one color of the at least one graphical element; and
a description of functionality of the electronic device represented by the at least one graphical element.

25. The behavior template, as set forth in claim 24, wherein the description of at least one graphical element comprises a description of the shape, form and color of at least one button for display on a display screen.

26. The behavior template, as set forth in claim 24, wherein the description of functionality comprises a description of at least one scene in a multimedia storage device accessible by the electronic device.

27. The behavior template, as set forth in claim 24, wherein the description of functionality comprises a description of functions associated with the electronic device.

28. An article of manufacture comprising:
a computer-readable medium having encoded therein:
a description of at least one graphical element;
a description of placement of the at least one graphical element; and
a description of functionality of the electronic device represented by the at least one graphical element.

29. The article, as set forth in claim 28, comprising:
an optional description of a background for displaying the at least one graphical element; and
an optional description of at least one color of the at least one graphical element.

30. The article, as set forth in claim 28, wherein the description of at least one graphical element comprises a description of the shape, form and color of at least one button for display on a display screen.

31. The article, as set forth in claim 28, wherein the description of functionality comprises a description of at least one scene in a multimedia storage device accessible by the electronic device.

32. The article, as set forth in claim 28, wherein the description of functionality comprises a description of functions associated with an electronic device.
